(19) United States
(12) Patent Application Publication
(10) Pub. No.: US 2002/0169964 A1
(43) Pub. Date: Nov. 14, 2002

(54) Procedure and device for generating a signature

(76) Inventor: Thorsten Klook, Rostock (DE)

Correspondence Address: Alan B. Clement, HEDMAN & COSTIGAN, P.C., 1185 Avenue of the Americas, New York, NY, 10036, US

(21) Appl. No.: 10/032,224

(22) Filed: Dec. 21, 2001

(30) Foreign Application Priority Data
Apr. 23, 2001 (DE) DE10119934.1

(51) Int. Cl. H04L 9/00

(52) U.S. Cl. 713/178

(57) ABSTRACT

The object of the invention is a procedure and a device for generating a signature, in particular a time signature.

The invention relates to a procedure and device for generating a signature, in particular a time signature.

In many cases, it is necessary to verify whether a specific document is present at a specific time, or verify other kinds of information in certified form. This can usually be done by receipt stamp, postmark, registered letter or notary certification. However, such methods cannot be applied to electronic documents or data. In addition, they are either easy to manipulate or expensive.

Therefore, electronic documents receive electronic time signatures. Electronic time signatures involve a procedure to link and seal digital documents and data with the legally valid time. If the document and time signature are on hand, it can be documented after the fact that the document had existed in precisely this form at a specific time. When requested, the applicant relays time signatures via an Internet connection. For example, a requester can be a clerk in a registration office, who updates or generates an electronic registry entry, or a builder who files a quality-inspected CAD drawing, a scan operator at a bank who archives contractual documents, a multimedia content server who distributes digital objects, such as musical pieces or films, via the Internet for temporary usage, or the software system of a manufacturer that transmits orders to the system of the supplier via the Internet.

In general, a digital document or a procedure is always time-stamped if recording is subject to some documentation-related obligation, or if recording is done for one's own purposes to attain verifiability.

Technically speaking, a digital time signature is a digital signature on a document to which the legally valid current time has been unforegeably appended. In addition to the necessary communication components, time signature generation requires an unmanipulable time source and another unit that electronically “signs” the submitted data along with the valid time, protected against manipulation.

Known from DE 195 32 617 C2 is a procedure for sealing digital data, in which an external time signal is received and, after this signal has been checked for veracity, appended to the digital data to be stamped. The time-stamped digital data are then encrypted.

A known procedure for generating a timestamp shall be described below:

An electronic file, hereinafter referred to as user data N_{D}, is to be time-stamped. In order not to have to send the user data in plain text via the Internet, the HASH value of the data (N_{D}) is already generated by the requester. Time t is appended to the user data at the timestamp facility, thus resulting an a data tuple [H (N_{D}), t]. The HASH value H [H (N_{D}), t] is again formed and signed to sign this data tuple. This value is sent back to the requestor along with information about the stamped time.

The requester has the user data from which he can clearly determine the HASH value H (N_{D}). In addition, he knows the time t at which the timestamp was generated, and the time-stamped file H [H (N₀), t]. To check the timestamp, the HASH value of the data tuple must again be formed out of the HASH value of the user data and time, signed and compared with the signed value Sig (H [H (N₀), t]). If both files match, the specified time information is correct.

The hardware used to generate the timestamp consists of a computer for receiving the data to be stamped and running protocol software, a time signal receiver and standardized special hardware, which electronically “signs” the submitted data along with the valid time, protected against manipulation. The current system architecture uses a smart card for this purpose.

The timestamp is here as accurate as the accuracy of the supplied time information. There are various suggestions for checking the supplied time information for plausibility, e.g., from DE 195 32 617 C2 already mentioned above, according to which the received time signal is compared with an internal clock. However, the entire timestamp system must be unmanipulable for such a plausibility check. This can be achieved with strict hardware access controls. While it is improbable that an entire timestamp system will be illegally used, there is a certain danger in the current system architecture that a smart card could be removed from a timestamp system and used in conjunction with other hardware. One cannot tell from the timestamp which hardware was used to generate it. Therefore, time information is not verified, and can be manipulated.

The object of the invention is to link the signature unit of a certification system with the certification unit in such a way as to make it impossible to solely use one or the other component with unauthorized hardware. In particular, the invention is to be applicable to timestamp devices.

The object is achieved according to the invention by a procedure for generating a signature with a certification system, which encompasses a certification unit and a signature unit, characterized in that the certification unit appends the file to be signed with certification information and authentication information, and the signature unit signs the supplemented file.

In particular, the certification unit can be a timestamp unit that appends the file to be signed with time information. In the following, the invention will be described in greater detail using a certification system with timestamp unit. However, it goes without saying that the invention can be used for any certification system in which a file to be signed is supplemented with information.

The procedure according to the invention makes it possible to later track whether a specific timestamp unit generated the timestamp.

The procedure according to the invention makes it impossible to use the timestamp unit and signature unit separately from each other. A signature unit can be a mobile data carrier with intelligent logic, which must be plugged into the timestamp unit, and there signs the data sent to it by the timestamp unit. The mobile data carrier with intelligent logic can be a smart card, for example.

The authentication information consists of an authentication code a, a secret value, for which there is an unambiguous public value a′ that cannot be used from outside to infer a. Authentication codes can preferably be a message authentication code (MAC) or a digital signature.

The invention also proposes a device for generating a signature (certification system) that encompasses a certification unit and signature unit. The device according to the invention is characterized in that the certification unit supplies certification information and authentication information.

It can in turn preferably involve a device for generating a time signature, in which the certification information is time information. The invention will be explained below based on this example, without being understood to be limited to this application.

The device according to the invention alters the procedure according to the invention in such a way that, in addition to the time information, the timestamp unit (generally referred to as the certification unit) supplies other information that is appended to the file to be stamped, and serves to identify the timestamp unit. The authentication information is a secret of the timestamp unit, and proves that the timestamp was actually generated with time information from this timestamp unit.

A timestamp is only as reliable as the authority that generated the timestamp. A timestamp device can essentially be divided into two parts, namely into the part that routinely processes the supplied data, and supplements them with time information. Manipulations of the time signal must be prevented in this part. Such manipulations can be countered by technical means. The second part of the certification system encompasses the signature area. The signature code must here be changed as required if it is suspected that the code has been decrypted. In terms of system architecture, it is therefore advantageous to make this part readily exchangeable, e.g., design it as a mobile data carrier with intelligent logic, such as a smart card or a PCI card.

However, this makes it possible to remove the signature unit from the system and use it with a second certification system that is relatively easy to manufacture. The data do make it possible to infer which timestamp unit the signature unit was used in combination with after the fact. Therefore, manipulations in this part are only to be prevented through strict access controls. It appears relatively improbable that the certification system will be misused, since the complete hardware must be removed for this purpose. However, removing a signature unit in the form of a smart card does lie within the realm of the possible, even if strict safety precautions are enacted.

The procedure according to the invention now provides that the essentially permanently installed timestamp unit appends authentication information specific to the timestamp unit to the files to be signed in addition to the time information (generally referred to as certification information). Based on this information, which must be kept secret, a check can be performed at any subsequent point desired to determine whether the signature of the mobile data carrier with intelligent logic, e.g., a smart card, took place in conjunction with a timestamp of this timestamp unit or not.

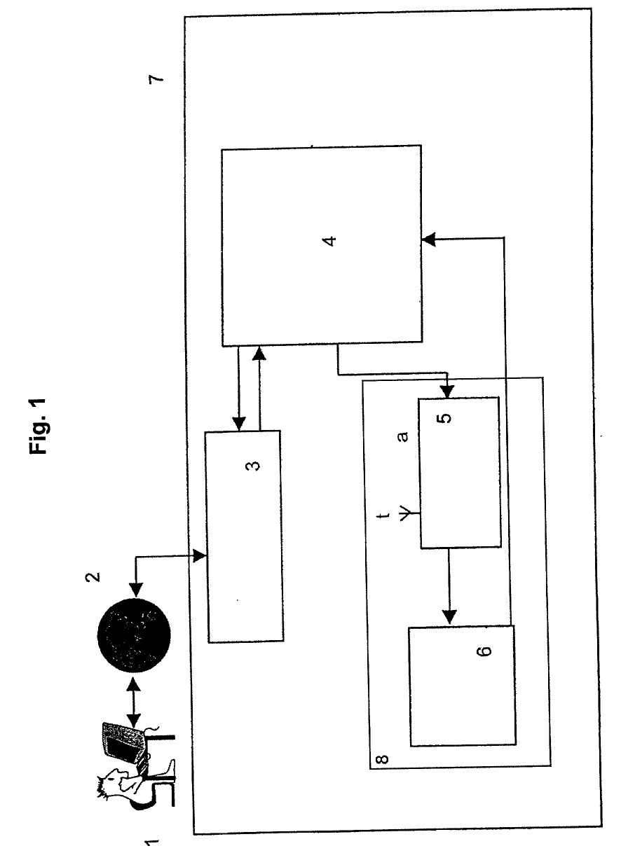

The procedure according to the invention will be described below based on an example and the attached FIG. 1:

A user 1 wants to have a time signature appended to user data, e.g., a text file. He sends the user data to a time signature service 7 via a suitable application environment, e.g., via the Internet 2. In order not to send the user data over the Internet unencrypted, the appropriate software is used for encryption purposes beforehand, e.g., by forming the HASH value. The user data are received at the time signature service 7 via a communication server 3. They are relayed to a timestamp unit 5 as part of the certification system 8 via a computer system 4 that uses protocol software. Time information t is appended there. In addition, the timestamp unit 5 has secret authentication information a, which is also appended to the file. The file provided with time information and information about the timestamp unit is appended to the signature unit 6, also part of the certification system 8, which generates a signed file from the data tuple comprised of user data, time information and authentication information by again generating and signing the HASH value. The signature obtained in this way is transmitted back to the user 1 as a data tuple along with information about the initial user data and the stamped time. Therefore, the user has a signed file as well as plain text information about the data sent to the timestamp service, the stamped time and used timestamp service. He can check the time signature by resending the data sent to the time signature service along with the time indication. The time signature service then executes the same encryption again. The same file must be obtained as a result. If it is not, the data about time and/or the used timestamp unit are false.

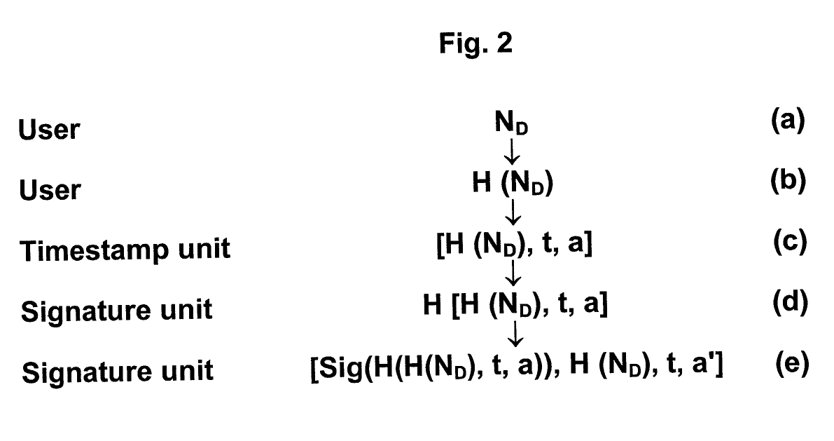

The way in which the data transmitted by the user are basically processed will be described with reference to FIG. 2:

The user initially has user data N_{D} (a). The application software of the user forms the HASH value H (N_{D}) (b) for encrypted data transmission. The timestamp unit appends an indication as to time t and a secret authentication information a to the HASH value H (N_{D}). This yields the data tuple [H (N_{D}), t, a] (c).

The signature unit again generates the HAS value (d) from this data tuple and signs it. Together with additional non-secret or user-decodable plain text information, this signature forms the data tuple [Sig(H(H(N_{D}), t, a)), H(N_{D}), t, a′] (e), which is sent back to the user. In this case, a′ is an indicator that identifies the timestamp unit, but does not correspond to the secret authentication information a. As a public code, a′ is directly and clearly linked with a by a secret allocation.

When checking the time signature, the user again sends the data tuple to the timestamp authority. There, the identification indicator a′ can be used to identify the timestamp unit with which the timestamp was made. Again generating the HASH value of the data tuple comprised of HASH value, user data, time and authentication information yields a value that must match the value contained in the data tuple of the user. Otherwise, the time signature has been manipulated.

1. A procedure for generating a digital signature with a certification system (8), which encompasses a certification unit (5) and signature (6), characterized in that the certification unit (5) appends information t and authentication information a to the file to be signed, and the supplemented file is signed by the signature unit (6).

2. The procedure according to claim 1, characterized in that the certification unit is a timestamp unit (5), and the information is time information t.

3. The procedure according to claim 1 or 2, characterized in that the signature unit (6) is given intelligent logic via a mobile data carrier.

4. The procedure according to one of claims 1 to 3, characterized in that the authentication information consists of an authentication code a, which is a secret value, for which there is an unambiguous public value a′ that cannot be used from outside to infer a.

5. The procedure according to one of claims 1 to 3, characterized in that the authentication code is a digital signature.

6. A device (8) for generating a signature (d) comprising a certification unit (5) and a signature unit (6), characterized in that the certification unit (5) supplies information t and authentication information a.

7. The device (8) according to claim 6, characterized in that the certification unit is a timestamp unit (5), and the information is time information t.

8. The device (8) according to claim 6 or 7, characterized in that the certification unit (5) and signature unit (6) can be separated from each other, and the certification unit (5) is preferably permanently installed and secured against access.

9. The device (8) according to one of claims 6 to 8, characterized in that the signature unit (6) is a mobile data carrier with intelligent logic.

10. The device (8) according to one of claims 6 to 8, characterized in that the signature unit (6) is a plug-in component with storage medium and intelligent logic.
